(19) United States
(12) Patent Application Publication
(10) Pub. No.: US 2010/0014839 A1
(43) Pub. Date: Jan. 21, 2010

(54) LIGHTING ASSEMBLY AND METHOD FOR PROVIDING COOLING OF A LIGHT SOURCE

(75) Inventors: Daniel J. Anton Benoy, Eindhoven (NL); Cornelis Jojakim Jalink, Eindhoven (NL); Simon Jacobus Maria Kuppens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/440,597

(22) PCT Filed: Sep. 10, 2007
(86) PCT No.: PCT/IB07/53627

§ 371 Date: Mar. 10, 2009

(30) Foreign Application Priority Data
Sep. 14, 2006 (EP) 06120627.2

(51) Int. Cl. H04N 5/00; F21V 29/00

(52) U.S. Cl. 386/117; 362/373

(57) ABSTRACT

The present invention relates to a lighting assembly (100) for providing cooling of a light source (101), the lighting assembly (100) comprising a heat sink (102) comprising a phase change material for dissipating heat generated by the light source (101), means (106) for active cooling of the heat sink (102), and means (105) for activating the active cooling means when the light source is switched off. The lighting assembly according to the present invention minimizes the necessary off period between two on periods when the light source is switched on consecutively multiple times. At the same time, the present invention provides a quiet and vibration free cooling of the light source during the on period of the light source, and subsequently boosts the dissipation of heat received by the heat sink comprised with the phase change material when the light source is switched off. The present invention also relates to a corresponding method for providing cooling of a light source for a lighting assembly.

### FIELD OF THE INVENTION

The present invention generally relates to a lighting assembly and a method for cooling a light source, and more specifically to an improved lighting assembly and a method for cooling a light source arranged in a video camera.

### DESCRIPTION OF THE RELATED ART

In a system comprising a high intensity light source, such as for example a halogen light source or a high output light emitting diode (LED), there is generally a need for an arrangement to dissipate the heat radiated by the light source, to maintain prescribed operating temperature ranges. Specifically, in relation to LEDs this is very important since sustained high operating temperatures have an adverse effect on LED lifetime and optical performance. High operation temperature will furthermore greatly accelerate lumen depreciation.

One exemplary application where an LED device would be advantageous is in a video camera for recoding images and sound, possibly arranged in a portable mobile phone. The LED would in this case act as an aid for illuminating a scene when recording at a low illumination level. In such a case, it is furthermore necessary to keep the LED device within the specific operating temperature range, since the spectral distribution of the LED will change if the temperature of the LED goes outside of the prescribed operating temperature range. A shift in spectral distribution will affect the white balance of the recording.

A general solution to this problem would be to arrange an active cooling device, such as a fan, in the vicinity of the LED for aiding the dissipation of the heat radiated by the light source. However, this solution is disadvantageous as the fan generates both noise and vibrations. The vibrations will affect the image stability, whereas the noise will distort the recorded sound.

US 2005/0276053 propose a solution to this problem, by means of an illumination system arranged in a video camera. The illumination system includes a plurality of LEDs, for generating controlled lighting conditions, a platform for supporting the LEDs, and a thermal facility, e.g. a heat sink, which may include a phase change material (PCM), to store heat generated by the LEDs.

Passive cooling by means of a phase change material is well known in the art, with specific application in for example small and lightweight portable electronic devices. A phase change material is a material composition which is capable of storing or releasing large amounts of energy. Initially, the solid-liquid PCMs perform like conventional storage materials, such as water; their temperature rises as they absorb dissipated heat. However, unlike conventional storage materials, when PCMs reach the temperature at which they change phase (their melting point) they absorb large amounts of heat without getting hotter. When the ambient temperature in the space around the PCM material drops, the PCM solidifies, releasing its stored latent heat. PCMs therefore absorb and emit heat while maintaining a nearly constant temperature.

However, when all phase change material in the heat sink is melted in the above disclosed illumination system; the temperature of the heat sink continues to increase until a steady temperature is reached. The time for reaching this steady state and the value of the steady state temperature is determined by the cooling surface and the sensible heat of the heat sink. After switching off the LEDs in the illumination system, the heat sink will cool down. The temperature of the heat sink decreases until the solidification temperature of the PCM (equal to the melting temperature), where further cooling of the heat sink is drastically slowed due to the temperature stabilization of the PCM. This poses a problem when the LEDs in the illumination system are switched on consecutively multiple times. When the off period between two switching on periods is too short, the start temperature at the switching on period is already too high, which seriously limits the second switched on period, thus staying within the specified operational temperature of the LEDs. One obvious solution would be to include more phase change material, but to keep the application lightweight and compact; this is not a feasible solution.

There is therefore a need for an improved lighting assembly and a method for cooling a light source, substantially overcoming at least some of the disadvantages of the prior art, and more specifically overcoming or at least alleviating the problem with cooling of a light source in a video camera.

### SUMMARY OF THE INVENTION

The above object is met by an improved lighting assembly and a method for cooling a light source, as defined in claim 1 and claim 8, respectively. The appended sub-claims define advantageous embodiments in accordance with the present invention.

According to an aspect of the invention, there is provided a lighting assembly for providing cooling of a light source, the lighting assembly including a heat sink comprising a phase change material for dissipating heat generated by the light source, means for active cooling of the heat sink, and means for activating the active cooling means when the light source is switched off.

As described above, in an assembly where the light source is switched on consecutively multiple times, the off periods between two periods of operation of the light source (i.e. the “on” period) has to be long enough to let the PCM arranged in the heat sink cool down enough to allow for an adequate length of the second on period of the light source. With an assembly according to the present invention, the off period can be shortened since the active cooling means boosts the dissipation of heat received by the heat sink comprised with the PCM when the light source is switched off (i.e. the “off ”period). At the same time, there is provided a quiet and vibration free cooling of the light source my means of the PCM during the period when the light source is switched on and the active cooling means is deactivated. Furthermore, the above assembly makes it possible to minimize the amount of phase change material that needs to be arranged in the heat sink, thereby making the assembly more compact, which is preferred for small handheld devices.

Preferably, the temperature of the heat sink is measured, for example using a temperature sensor arranged in the vicinity of the heat sink. The temperature is then compared to a first predetermined threshold, wherein the means for activating will activate the active cooling means if the temperature is above the first predetermined threshold. As understood by the skilled addressee, it might not always be necessary to activate the active cooling means subsequently after the light source has been switched on. This rather depends on the temperature of the heat sink after an on period, the size of the heat sink, the amount of PCM arranged in the heat sink, the presumed subsequent on period, the ambient temperature, etc.

In a preferred embodiment, the heat sink comprises an array of channels, the phase change material is arranged around the channels, and a cooling airflow provided by the active cooling means is flowing through the channels. This might for example be achieved by arranging the phase change material in a reservoir, wherein the reservoir comprises through holes or through channels, and the outflow of the active cooling means has been connected to the through holes of the reservoir. In some implementations this might be an advantageous solution, not only since it accelerate the dissipation of heat received by the heat sink, but since the cooling air-flow in this case not necessarily needs to flow around the outside of the heat sink.

The active cooling means may for example be provided by a synthetic jet module, a electric fan, or a piezo-electric cooler. The synthetic jet is a preferred embodiment since it is both compact and very effective. A typical synthetic jet comprises an acoustic actuator (piezo-electric element) at one side of a small chamber opposed by a small orifice, usually a hole or slit. Applying a voltage to the acoustic actuator causes it to vibrate, and outside air is rapidly pulled into the chamber through the orifice, and then expelled turbulently.

It may also be advantageous to include a function to override the activation of the active cooling means if the temperature of the heat sink rises above a second predetermined threshold. This will allow for the possibility to activate the active cooling means if for example the on period has been so long such that the heat sink comprising the phase change material reaches the maximum operation temperature. As discussed above, exceeding the maximum prescribed operation temperature would drastically limit the lifetime of the light source.

Preferably, the light source is comprised in the lighting assembly.

In one embodiment, the above-described lighting assembly is arranged in a video camera system, which additionally comprises a video camera adapted to record images. In a video camera system, such as for example a consumer video camera system, there is a need for a light source for illuminating the scene to be recorded by the video camera system when the scene is to dark too be successfully recorded. As understood, the light source should preferably be very bright, which generally will result in that the light source becomes very warm. The video camera system furthermore has to be compact. By using an arrangement as discussed above, it is possible to design a compact video camera system, since the heat sink arranged to receive the heat dissipated from the light source can be small due to the advantageous combination of active and passive cooling means as described above. The active cooling means will not disturb the recording since it (in general) is switched off when the light (and thus the recording) is on. Instead, the active cooling takes place when the recording and lights are off.

According to another aspect of the invention, there is provided a method for providing cooling of a light source for a lighting assembly, the lighting assembly including a heat sink comprising a phase change material for dissipating heat generated by the light source, and means for active cooling of the heat sink, the method comprising the step of activating the active cooling means when the light source is switched off As described above in relation to the first aspect of the invention, this method shortens the necessary off period for the light source, while at the same time provides a quiet and vibration free cooling of the light source By means of the phase change material) during the on period of the light source.

Further features of, and advantages with, the present invention will become apparent when studying the appended claims and the following description. Those skilled in the art realize that different features of the present invention can be combined to create embodiments other than those described in the following.

### BRIEF DESCRIPTION OF THE DRAWINGS

These and other aspects of the present invention will now be described in more detail, with reference to the appended drawings showing currently preferred embodiments of the invention, wherein:

FIG. 1 is a schematic block diagram showing an embodiment of a lighting assembly according to an embodiment of the present invention;

FIG. 2 is a graph illustrating the temperature of the phase change material arranged inside of the heat sink during operation of the lighting assembly shown in FIG. 1; and

FIG. 3 schematically illustrates a video camera system comprising a lighting assembly according to an embodiment of the present invention.

### DETAILED DESCRIPTION OF CURRENTLY PREFERRED EMBODIMENTS

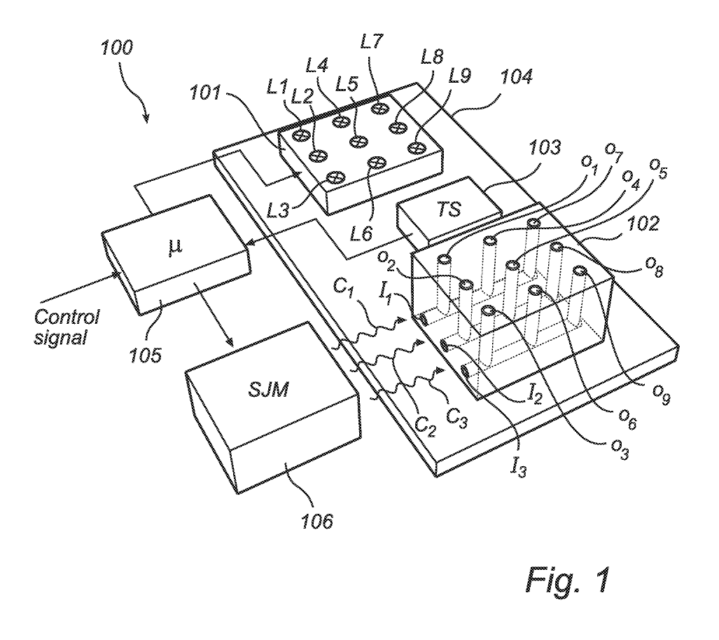

Referring now to the drawings and to FIG. 1 in particular, there is depicted a schematic block diagram showing a lighting assembly 100 comprising a lighting module 101 which consists of nine light emitting diodes (LEDs) L₁-L₉, and a hermetically sealed heat sink 102 having a phase change material (PCM) arranged inside of the heat sink 102. The lighting module 101 and the heat sink 102 are together with a temperature sensor 103 arranged on a plate 104, thermally coupling the lighting module 101, the heat sink 102, and the temperature sensor 103 together with each other. The assembly 100 further comprises activation means, in the illustrated embodiment a control unit 105, adapted to receive a signal from the temperature sensor 103, and to control the lighting module 101. The control unit 105 also controls an active cooling device in the form of a synthetic jet module 106, which outputs a cooling airflow, indicated by arrows C₁-C₃. The cooling airflow outputted by the synthetic jet module 106 is received by three corresponding inputs I₁-I₃ of the heat sink 102. Channels arranged inside of the hermetically sealed heat sink 102 and surrounded by the phase change material connects the inputs I₁-I₃ and outputs O₁-O₉ arranged on top of the heat sink 102. In one embodiment, the hermetically sealed heat sink 102 is arranged in a comb-like way, wherein the outputs O₁-O₉ are arranged in the spaces between the teeth of the comb. Generally, the heat sink is constructed from a material having high thermal conductivity, such for example aluminum, and arranged such that it has a thermal connection with the light source.

The lighting module 101 may include any number of LEDs. The lighting module 101 can also, or instead, comprise other types of light sources, such as for example OLEDs, PLEDs, (solid state) lasers or a combination thereof. The same counts for the heat sink 102, which can comprise different types of phase change materials, such as for example a paraffin based PCM. Furthermore, the cooling airflow can be arranged to cool the heat sink 102 by cooling the outsides of the heat sink 102, or a combination thereof. Generally, the synthetic jet module 106 is simple and comprises no friction parts to wear out. Furthermore, the synthetic jet module 106 in principle resembles a tiny stereo speaker in which a diaphragm is mounted within a cavity that has one or more orifices. Electromagnetic or piezoelectric drivers cause the diaphragm to vibrate 100 to 200 times per second, sucking surrounding air into the cavity and then expelling it. The rapid cycling of air into and out of the module creates pulsating jets that can be directed to the precise locations where cooling is needed, in this case to the inputs I₁-I₃ of the heat sink 102.

The control unit 105 may include a microprocessor, microcontroller, programmable digital signal processor or another programmable device. The control unit 105 may also, or instead, include an application specific integrated circuit, programmable gate array logic, a programmable logic device, a digital signal processor, or the like. Where the control unit 105 includes a programmable device such as the microprocessor or microcontroller mentioned above, the processor may further include computer executable code that controls operation of the programmable device.

During operation of the lighting assembly 100, the control unit 105 receives a control signal indicating that the lighting module 101 is to be activated. The control unit 105 activates the lighting module 101 such that the LEDs L₁-L₉ are switched on, and light will be emitted from the lighting assembly 100. The heat sink 102 comprising PCM will in this case provide passive cooling of the lighting module 101. The control unit 105 again receives a control signal indicating that the lighting module 101 should be switched off, and/or that the system in which the lighting assembly 100 is arranged is not sensitive to noise and vibrations generated by the synthetic jet module 106. The control unit 105 will switch the lighting module 101 off. At this point, the control unit 105 will instead activate the active cooling means, i.e. the synthetic jet module 106. The synthetic jet module 106 which will start to generate a cooling air-flow which will start to cool down the heat sink 102 comprising PCM, thereby speeding up the solidification state of the PCM arranged inside of the heat sink 102. Thereafter, if the lighting module 101 is turned on again, the synthetic jet module 106 is switched off.

Optionally, it is possible to compare a sampled temperature signal received from the temperature sensor 103, relating to the temperature of the thermally connecting plate 104, to a first predefined temperature threshold. This first predefined threshold stands in relation to the melting temperature of the phase change material. In this optional case, the control unit 105 will only activate the synthetic jet module 106 if the temperature is found to be above the first predefined temperature threshold and the lighting module 101 is switched off. At the same time, the control unit 105 will start to periodically sample a temperature signal received from the temperature sensor 103, relating to the temperature of the thermally connecting plate 104, and thereby the temperature of the heat sink 102.

As a safety precaution, the temperature can be continuously sampled, even when the lighting module 101 is switched on. In this case, the temperature is compared to a second predefined temperature threshold which stands in relation to a maximum operation temperature of the LEDs L₁-L₉. If the temperature measured by the temperature sensor 103 is found to be above the maximum operation temperature of the LEDs L₁-L₉, the control unit 105 overrides the general control pattern of the control unit 105, and activates the synthetic jet module 106, even though the lighting module 101 is switched on, which in that case will start to actively cool down the heat sink 102. However, generally this is not necessary, and furthermore might provide an interference in the case that the system in which the lighting assembly 100 is arranged is sensitive to noise and vibrations generated by the synthetic jet module 106.

As understood by the skilled addressee, the lighting assembly 100 discussed above can be an integrated unit, wherein for example the bottom of the heat sink 102, in this case having integrated active cooling means, constitutes the bottom of a fitting for the lighting module 101. The control unit 105 can be integrated together with the lighting assembly 100. Processing means in a system in which the lighting assembly 100 is comprised can also be used instead of, or together with, the dedicated control unit 105.

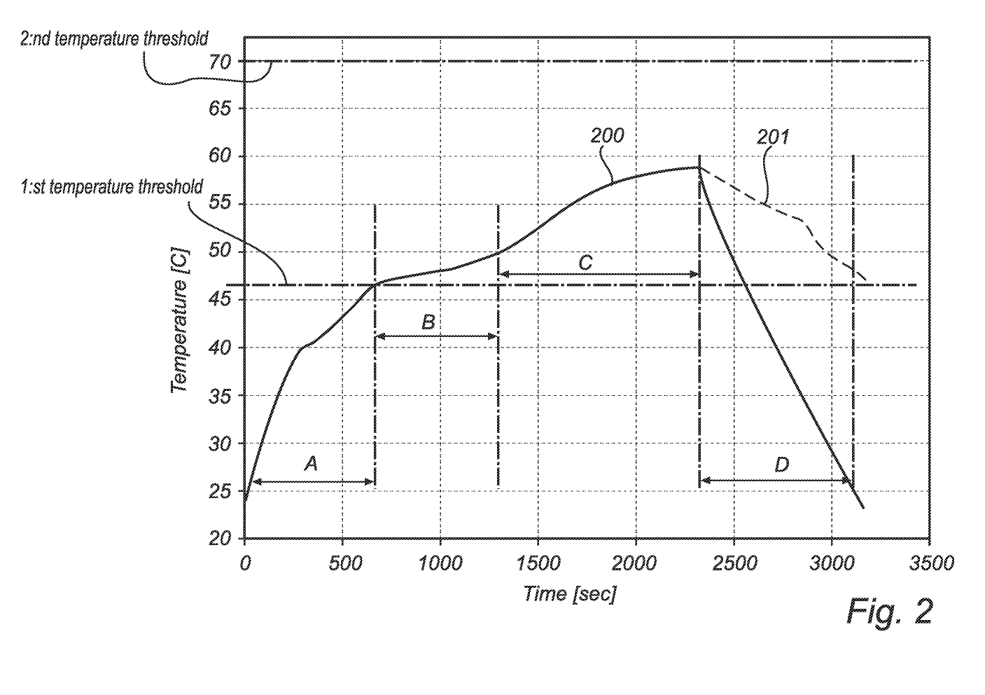

In FIG. 2 there is depicted a graph 200 illustrating the relationship between the temperature of the phase change material arranged inside of the heat sink 102 during operation of a lighting assembly 100 according to the present invention, and the different time periods, e.g. four different “sections”, during which the heat sink 102 is heated by light radiated from the light module 101 and cooled down by the active cooling means. The PCM is in this embodiment a paraffin based phase change material.

In the first section, A, the lighting module 101 is switched on and the temperature of the PCM starts to increase until it reaches the melting temperature of the PCM. The first predefined temperature threshold is in the described embodiment selected to be the same as the melting temperature of the PCM, e.g. 47° Celsius. Further, the temperature increase of the heat sink is then in section B slowed down since this is where the PCM change phase and absorbs a large amount of the heat dissipated by the lighting module 101 without getting that much hotter.

However, in section C, all of the PCM has melted, and the temperature of the heat sink 102, and consequently the temperature of the PCM in the heat sink 102 will continue to rise until a maximum steady state temperature of the heat sink 102. Generally, the size of the heat sink 102, and the amount of PCM arranged inside of the heat sink 102 is designed such that the steady state temperature of the heat sink 102 will not exceed a maximum operation temperature of the lighting module 101. However, in some cases, for example when the environmental temperature in which the lighting assembly 101 operates is very high, it might be necessary, as described above, to override the activation of the active cooling means, and activate the synthetic jet module 106 even though the lighting module 101 is switched on. The second temperature threshold is in this case selected to the maximum operation temperature of the lighting module 102, e.g. 70° Celsius. Furthermore, it is in an alternative embodiment possible to adjust the cooling airflow from the active cooling means. For example, in the case wherein the active cooling means is a fan, this can be achieved by adjusting the speed of the fan. This would minimize the introduction of noise and vibrations, for example in the case where the activation of the active cooling means is overridden.

In section D, the lighting module 101 is switched off, and the active cooling means is activated. The synthetic jet module 106 will provide a rapid temperature decrease of the phase change material such that the off period is minimized, thus making it possible to subsequently switch on the lighting module 101 without having the problems with a too high start temperature at the next switching on period of the lighting module 101. This will extend the second switched on period, thus making it much easier to stay within the specified operational temperature of the LEDs for a longer time period without activating the active cooling means when the LEDs are switched on. Keeping within the operation temperature ranges will generally extend the lifetime of the light sources, e.g. LEDs.

Section D furthermore depict a dotted line 201 illustrating the temperature decrease of the phase change material in a prior art arrangement, wherein no active cooling is used when the light source is switched off. The temperature decrease of the phase change material is in this case much slower. As understood by the skilled addressee, the time difference in temperature decrease from a maximum temperature of the PCM to a desired temperature, between an arrangement according to the invention and a prior art arrangement, relates, among other things, to the capacity of the active cooling means.

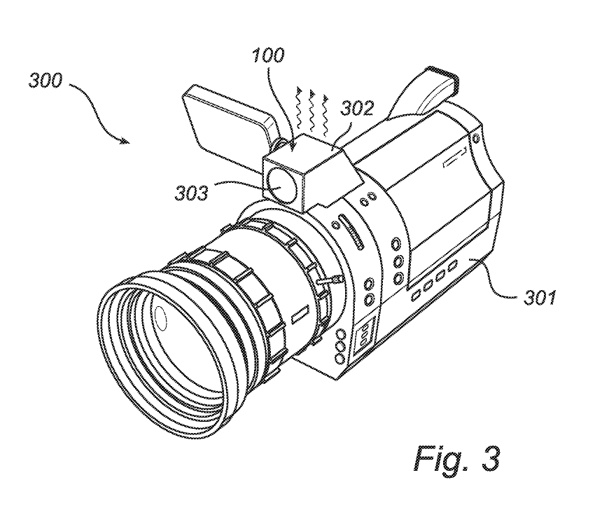

FIG. 3 illustrates a video camera system 300 comprising a video camera 301 adapted to record images, and a lighting assembly 100 as described above in relation to FIG. 1. The lighting assembly 100 has been integrated in a video flash unit 302, further comprising a lens 303 for focusing the light emitted by the lighting assembly 100. The video flash unit 302 is furthermore supplied with means for allowing an airflow through the through channels of the heat sink 102 (not shown). In the case that the active cooling in the video flash unit 302 is provided by means of a fan, it is necessary to provide the video flash unit 302 with both inlet and outlet holes. However, when the active cooling in the video flash unit 302 is provided by means of a synthetic jet, the cooling inlet holes are not required. As discussed above, the active cooling will not disturb the recording since it (in general) is switched off when the light (and thus the recording) is on. Instead, the active cooling takes place when the recording and lights are off.

The person skilled in the art realizes that the present invention by no means is limited to the preferred embodiments described above. On the contrary, many modifications and variations are possible within the scope of the appended claims. For example, the present invention may also be combined with different types of compact electronic devices, such as for example color variable LED flash units with continuous mode or elevator LED lighting. Furthermore, it would be possible to design the heat sink such that it comprises normal heat sink flanges for further facilitating the cooling of the heat sink. Such an embodiment might be necessary if for example implementation limitations makes it impossible to integrate through channels surrounded by the PCM inside of the heat sink.

1. A lighting assembly (100) for providing cooling of a light source (101), said lighting assembly (100) comprising:
a heat sink (102) comprising a phase change material for dissipating heat generated by said light source (101);
means (106) for active cooling of said heat sink (102); and
means (105) for activating said active cooling means when said light source is switched off.

2. A lighting assembly according to claim 1, wherein said activation means is further adapted to activate said active cooling means when said light source is switched off and the temperature of the heat sink is above a first predetermined threshold.

3. A lighting assembly according to claim 1, wherein said heat sink comprises an array of channels, said phase change material is arranged around said channels, and a cooling air-flow provided by said active cooling means is adapted to flow through said channels.

4. A lighting assembly according to claim 1, wherein said active cooling means is selected from a group comprising a synthetic jet module, a fan, and a piezo-electric cooler.

5. A lighting assembly according to claim 1, wherein said activation means is further adapted to override said activation of said active cooling means if the temperature of the heat sink is above a second predetermined threshold.

6. A lighting assembly according to claim 1, wherein the light source is comprised in the lighting assembly.

7. A video camera system (300), comprising:
a video camera (301) adapted to record images; and
a lighting assembly (100) according to claim 1.

8. A method for providing cooling of a light source (101) for a lighting assembly (100), said lighting assembly (100) comprising a heat sink (102) comprising a phase change material for dissipating heat generated by said light source (101), and means (106) for active cooling of said heat sink (102), said method comprising the step of:
activating said active cooling means (106) when said light source (101) is switched off.
